(19) United States
(12) Patent Application Publication
(10) Pub. No.: US 2026/0326790 A1
(43) Pub. Date: Oct. 22, 2026

(54) INTELLIGENT DRIVING RISK EARLY-WARNING METHOD AND APPARATUS, ELECTRONIC DEVICE, MEDIUM, AND PRODUCT

(71) Applicants: ZHEJIANG GEELY HOLDING GROUP CO., LTD., Hangzhou (CN); GEELY AUTOMOBILE RESEARCH INSTITUTE (NINGBO) CO., LTD., Ningbo (CN)

(72) Inventors: Qili LI, Hangzhou (CN); Lisheng HOU, Hangzhou (CN); Zhengkai LIAO, Hangzhou (CN); Xueyan GONG, Hangzhou (CN); Qingmeng HUO, Hangzhou (CN)

(73) Assignees: ZHEJIANG GEELY HOLDING GROUP CO., LTD., Hangzhou (CN); GEELY AUTOMOBILE RESEARCH INSTITUTE (NINGBO) CO., LTD., Ningbo (CN)

(21) Appl. No.: 19/695,262

(22) Filed: Jun. 2, 2026

Related U.S. Application Data
(63) Continuation of application No. PCT/CN2025/090824, filed on Apr. 24, 2025.

(30) Foreign Application Priority Data
Apr. 25, 2024 (CN) 202410507126.1

(51) Int. Cl. B60W 60/00; B60W 30/09; B60W 30/095; B60W 30/18

(52) U.S. Cl. CPC B60W 60/0015; B60W 30/09; B60W 30/0953; B60W 30/0956; B60W 30/18163; B60W 2520/105; B60W 2554/4042

(57) ABSTRACT

An intelligent driving risk warning method is applied to a first vehicle and includes: in response to determining that the first vehicle is in an intelligent driving state, acquiring vehicle driving information; in response to determining that the vehicle driving information satisfies a preset potential risk condition, performing risk data detection; and in response to determining, by performing risk assessment based on risk data through a preset risk assessment model, that the first vehicle has an intelligent driving risk, outputting intelligent driving risk warning information.

### CROSS-REFERENCE TO RELATED APPLICATIONS

The present application is a continuation application of International Application No. PCT/CN2025/090824, filed on Apr. 24, 2025, which claims priority to Chinese Patent Application 202410507126.1, filed on Apr. 25, 2024. All of the aforementioned applications are incorporated herein by reference in their entireties.

### TECHNICAL FIELD

The present application relates to the technical field of vehicle, and in particular to an intelligent driving risk warning method, an apparatus, an electronic device, a storage medium, and a product.

### BACKGROUND

With the rapid development of intelligent driving technology, intelligent driving technology has been applied to an increasing number of vehicles. Consequently, the safety of intelligent driving has drawn increasing attention. At present, drivers are mainly informed, through user manuals, how to safely use intelligent driving functions, so as to improve their understanding of such functions and thereby effectively avoid safety accidents caused by human factors. However, the intelligent driving system itself may also make erroneous decisions due to precision limitations, errors, and the like, thereby performing incorrect actions or losing control actions. Therefore, the system limitations still present a relatively high safety risk.

### SUMMARY

A main objective of the present application is to provide an intelligent driving risk warning method, an apparatus, an electronic device, a storage medium, and a product, so as to solve the technical problem in the related art that safety risks are relatively high during intelligent driving due to system limitations.

To achieve the above objective, the present application provides an intelligent driving risk warning method. The intelligent driving risk warning method is applied to a first vehicle and includes the following steps:
in response to determining that the first vehicle is in an intelligent driving state, acquiring vehicle driving information;
in response to determining that the vehicle driving information satisfies a preset potential risk condition, performing risk data detection; and
in response to determining, by performing risk assessment based on risk data through a preset risk assessment model, that the first vehicle has an intelligent driving risk, outputting intelligent driving risk warning information.

The present application further provides an intelligent driving risk warning apparatus. The intelligent driving risk warning apparatus is applied to a first vehicle and includes an acquisition module, a detection module and an output module.

The acquisition module is configured to, in response to determining that the first vehicle is in an intelligent driving state, acquire vehicle driving information.

The detection module is configured to, in response to determining that the vehicle driving information satisfies a preset potential risk condition, perform risk data detection.

The output module is configured to, in response to determining, by performing risk assessment based on risk data through a preset risk assessment model, that the first vehicle has an intelligent driving risk, output intelligent driving risk warning information.

The present application further provides an electronic device. The electronic device is physical device and includes a memory, a processor, and a program for implementing the intelligent driving risk warning method, stored in the memory and executable on the processor. When the program is executed by the processor, the steps of the above intelligent driving risk warning method are implemented.

The present application further provides a medium. The medium is a computer-readable storage medium on which a program for implementing the intelligent driving risk warning method is stored. When the program is executed by a processor, the steps of the above intelligent driving risk warning method are implemented.

The present application further provides a computer program product including a computer program. When the computer program is executed by a processor, the steps of the above intelligent driving risk warning method are implemented.

According to the intelligent driving risk warning method, apparatus, electronic device, storage medium, and product provided in the present application, the intelligent driving risk warning method is applied to the first vehicle having an intelligent driving function. First, by acquiring vehicle driving information in response to determining that the first vehicle is in the intelligent driving state, monitoring of the first vehicle in the intelligent driving state is achieved. Further, by performing risk data detection in response to determining that the vehicle driving information satisfies the preset potential risk condition, risk monitoring is achieved when the first vehicle has a potential risk. Further, by outputting intelligent driving risk warning information in response to determining, by performing risk assessment based on the risk data through the preset risk assessment model, that the first vehicle has an intelligent driving risk, timely risk warning is achieved. In this way, if an intelligent driving decision violates the driver's intention or environmental safety requirements due to system limitations, a human driver, after receiving the intelligent driving risk warning information, can make a timely judgment and intervene to control the vehicle, thereby avoiding risks. Therefore, the technical defect is overcome that the intelligent driving system itself may make erroneous decisions due to precision limitations, errors, and the like, thereby performing incorrect actions or losing control actions, such that the system limitations still present a relatively high safety risk. Thus, safety vulnerabilities of intelligent driving attributable to system limitations are compensated for, and safety during the intelligent driving process is improved.

### BRIEF DESCRIPTION OF THE DRAWINGS

The accompanying drawings, which are incorporated into and form a part of this specification, illustrate embodiments consistent with the present application and, together with the specification, serve to explain the principles of the present application.

In order to more clearly illustrate the technical solutions in the embodiments of the present application or in the related art, the drawings to be used in the description of the embodiments or the related art will be briefly introduced below. Obviously, for those skilled in the art, other drawings may also be derived from these drawings without creative effort.

FIG. 1 is a schematic flowchart of an intelligent driving risk warning method according to an embodiment of the present application.

FIG. 2 is a schematic flowchart of an intelligent driving risk warning method according to an embodiment of the present application.

FIG. 3 is a schematic flowchart of an intelligent driving risk warning method according to an embodiment of the present application.

FIG. 4 is a schematic structural diagram of an intelligent driving risk warning apparatus according to an embodiment of the present application.

FIG. 5 is a schematic device structure diagram of a hardware operating environment involved in an intelligent driving risk warning method according to an embodiment of the present application.

FIG. 6 is a schematic flowchart of an intelligent driving risk warning method according to an embodiment of the present application.

FIG. 7 is a schematic flowchart of an intelligent driving risk warning method according to an embodiment of the present application.

The objectives, functional features, and advantages of the present application will be further described below in conjunction with the embodiments and with reference to the accompanying drawings.

### DETAILED DESCRIPTION OF THE EMBODIMENTS

In order to make the above objectives, features, and advantages of the present application more apparent and understandable, the technical solutions in the embodiments of the present application are clearly and completely described below with reference to the accompanying drawings in the embodiments of the present application. Obviously, the described embodiments are only some embodiments of the present application rather than all embodiments. All other embodiments obtained by those skilled in the art based on the embodiments of the present application without creative effort shall fall within the protection scope of the present application.

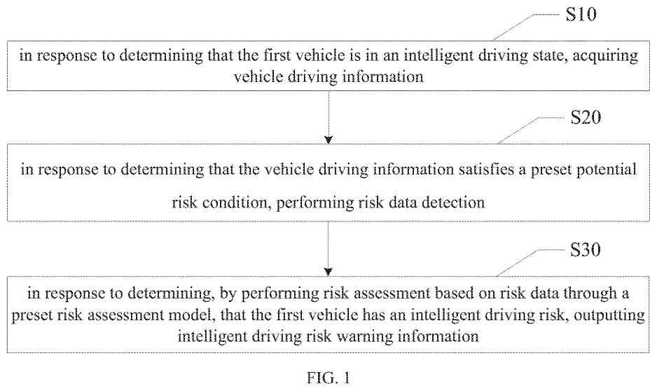

An embodiment of the present application provides an intelligent driving risk warning method. In a first embodiment of the intelligent driving risk warning method of the present application, with reference to FIG. 1, the intelligent driving risk warning method is applied to a first vehicle and includes the following steps.

Step S10, in response to determining that the first vehicle is in an intelligent driving state, acquiring vehicle driving information.

The executing subject of the method of this embodiment may be an intelligent driving risk warning apparatus, or an intelligent driving risk warning terminal device or server. In this embodiment, an intelligent driving risk warning apparatus is taken as an example. The intelligent driving risk warning apparatus may be integrated into terminal devices having data processing functions, such as a vehicle, an in-vehicle terminal, a vehicle control unit, a smartphone, and a tablet computer.

In this embodiment, the first vehicle has an intelligent driving function. In an embodiment, the intelligent driving function may be an advanced driving assistance system (ADAS) function. The intelligent driving state refers to a normal intelligent driving cruising condition, for example, an adaptive cruise control (ACC) mode, a highway assist (HWA) mode, or the like. The intelligent driving risk warning method is used to perform risk warning during the process in which the first vehicle is intelligently driven under intelligent driving control. In an embodiment, the intelligent driving risk warning apparatus may be deployed on the first vehicle. In another embodiment, the intelligent driving risk warning apparatus may be deployed on a server side. The specific arrangement may be determined according to actual conditions, and is not limited in this embodiment.

In an embodiment, the first vehicle further includes an intelligent driving system. The intelligent driving system includes at least one perception module, such as a radar, a camera, or the like. Each perception module independently perceives a target in the external environment and generates target object information, so that the intelligent driving system can make an intelligent driving decision based on the target object information.

Risk data refers to data that may cause the first vehicle to generate a risk in the intelligent driving state, and may include one or more of host vehicle state information, environmental perception information, and intelligent driving verification information. The host vehicle state information refers to state information of the first vehicle, including intelligent driving speed, vehicle speed, and the like. For example, if an intelligent driving speed sensor, vehicle speed sensor, or the like is abnormal or data transmission is delayed, an intelligent driving decision such as excessive intelligent driving speed or excessive intelligent driving angle may easily cause a safety accident. The environmental perception information refers to information of the environment in which the first vehicle is located, including road information, lane reference lines, target object information, and the like, wherein the targets include pedestrians, traffic facilities, and vehicles other than the first vehicle, and the target object information includes obstacle positions, target speeds, and the like. When the intelligent driving decision violates environmental safety intention, for example, where an intersection is not far ahead or the vehicle is currently at a sharp turn, inaccurate timing of intelligent driving or an excessively large or small intelligent driving angle may easily cause a collision accident. The intelligent driving verification information refers to information related to verifying the accuracy of the intelligent driving decision, including confidence levels of independently perceived environmental perception information as evaluated by the perception modules themselves, deviations among perception capabilities of the respective perception modules, sensor precision, and the like. For example, where radar and a camera are deployed on the vehicle, the vehicle actually needs to turn right at an intersection ahead, but there is a pedestrian crossing at the intersection. During some periods, the pedestrian may be occluded by other vehicles or pedestrians and cannot be detected. If the intelligent driving system controls the vehicle based on perception data that fails to detect the pedestrian, a safety accident may result. Where camera data transmission or image recognition is delayed, the position of the pedestrian perceived by the camera may differ greatly from the position of the pedestrian perceived by the radar. In such a case, if the intelligent driving system controls the vehicle based on the position of the pedestrian perceived by the camera, a safety accident may result. The perception accuracy of the perception modules is an important factor affecting intelligent driving decisions. However, environmental perception technology, sensor precision, data transmission delay, and the like may all affect the perception accuracy of the perception modules with respect to the external environment, thereby affecting the accuracy of intelligent driving decisions.

The vehicle driving information is used to characterize the current driving state of the first vehicle, and includes vehicle speed, acceleration, steering speed, fault information, and the like. When the driving state of the first vehicle is relatively gentle and stable, even if the first vehicle encounters a sudden fault or accident, the intelligent driving system or the driver has more time to discover and resolve the problem. However, when the first vehicle is in a highly uncertain state, such as a relatively high vehicle speed, relatively high acceleration, rapid steering, or the presence of faults, if a control instruction at a certain time step is erroneous, inaccurate, or delayed, the probability of risk is greatly increased. Compared with the risk data, the vehicle driving information is continuously detected during vehicle travel and usually does not require additional computation. Therefore, no additional detection or computing resources are consumed. Accordingly, by first monitoring the vehicle driving information and then performing risk data detection only when it is determined based on the vehicle driving information that the first vehicle has a potential risk, resources can be effectively saved. The specific manner and conditions for determining, based on the vehicle driving information, whether the first vehicle has a potential risk may be determined according to actual situations, vehicle calibration results, and the like, and are not limited in this embodiment.

As an example, step S10 includes: after the first vehicle is powered on and starts operating, continuously monitoring whether the first vehicle enters the intelligent driving state, and after detecting that the first vehicle enters the intelligent driving state, acquiring current vehicle driving information of the first vehicle.

Step S20, in response to determining that the vehicle driving information satisfies a preset potential risk condition, performing risk data detection.

As an example, step S20 includes: determining whether the vehicle driving information satisfies the preset potential risk condition; if the vehicle driving information satisfies the preset potential risk condition, determining that the first vehicle has a potential risk and further performing one or more risk item detections to obtain risk data respectively corresponding to the risk items, for example, if a risk item is acceleration, then the risk data is a specific value of the acceleration; and if the vehicle driving information does not satisfy the preset potential risk condition, risk data detection may be omitted, and the method may return to the step of acquiring vehicle driving information in response to determining that the first vehicle is in the intelligent driving state, so as to continuously detect whether the first vehicle has a potential risk. The preset potential risk condition may be determined according to actual situations, vehicle calibration results, and the like, and is not limited in this embodiment.

In an embodiment, the risk data may be the perception data itself or a difference between perception data generated at different times or by different sensors.

In another embodiment, the risk data may be assigned based on the perception data. For example, if a distance between a target detected by a camera and the first vehicle is less than or equal to a preset threshold, the risk data is set to 1; if the distance between the target detected by the camera and the first vehicle is greater than the preset threshold, the risk data is set to 0. If a category of a target detected by a radar is different from a category of a target detected by the camera, the risk data is set to 1; if the category of the target detected by the radar is the same as the category of the target detected by the camera, the risk data is set to 0. In this case, a corresponding high-risk warning condition may be set to be greater than 0. Therefore, when the distance between the target and the first vehicle is less than or equal to the preset threshold, or when the category of the target detected by the radar is different from the category of the target detected by the camera, the corresponding high-risk warning condition is satisfied and intelligent driving risk warning information is output. In this way, if computation or statistical analysis is required for different types of risk data, the computation amount is lower and the efficiency is higher.

The vehicle driving information includes at least one of host vehicle acceleration, host vehicle deceleration, and steering speed. The step of performing risk data detection in response to determining that the vehicle driving information satisfies the preset potential risk condition includes:
in response to detecting, among the vehicle driving information, target vehicle driving information satisfying the preset potential risk condition, detecting risk data corresponding to the target vehicle driving information, wherein the preset potential risk condition includes at least one of the host vehicle acceleration exceeding a second preset acceleration threshold, the host vehicle deceleration exceeding a second preset deceleration threshold, and the steering speed exceeding a second preset steering speed threshold.

In this embodiment, since the first vehicle has different risk points in different driving states, the required risk data to be detected is also different. For example, during acceleration, the risk points may focus on an inter-vehicle distance to a vehicle ahead and whether there is an intersection ahead; during deceleration, the risk points may focus on a vehicle speed of a following vehicle and whether a traffic participant suddenly cuts in or cuts out ahead. Therefore, a mapping relationship between driving states and risk items may be established in advance. In response to determining that target vehicle driving information satisfies the preset potential risk condition, a current target driving state of the first vehicle may be determined based on the target vehicle driving information; a target risk item corresponding to the target driving state may be determined according to the preset mapping relationship between driving states and risk items; and the target risk item may be detected, thereby obtaining risk data required for the current driving state of the first vehicle.

The potential risk condition includes at least one of the host vehicle acceleration exceeding a second preset acceleration threshold, the host vehicle deceleration exceeding a second preset deceleration threshold, and the steering speed exceeding a second preset steering speed threshold. The second acceleration threshold, the second deceleration threshold, and the second steering speed threshold may each be determined according to actual situations, vehicle calibration results, and the like, and are not limited in this embodiment.

As an example, it is determined whether respective pieces of vehicle driving information satisfy the preset potential risk condition; if target vehicle driving information satisfying the preset potential risk condition is detected among the vehicle driving information, the current target driving state of the first vehicle is determined according to the target vehicle driving information; the target risk item corresponding to the target driving state is determined according to the preset mapping relationship between driving states and risk items; and the target risk item is detected to obtain risk data required for the current driving state of the first vehicle.

Step S30, in response to determining, by performing risk assessment based on risk data through a preset risk assessment model, that the first vehicle has an intelligent driving risk, outputting intelligent driving risk warning information.

In this embodiment, since the detection process for various pieces of risk data and the determination process as to whether corresponding high-risk warning conditions are satisfied can each be independently performed, they may be executed in parallel or in a queued manner. Therefore, the times at which determination results are obtained may differ. After a preset quantity of target risk data satisfying preset high-risk warning conditions has been detected, it is unnecessary to continue consuming computing power to detect and determine other risk data, thereby saving computing resources. Moreover, it is unnecessary to wait until all the risk data has been detected before issuing a risk warning, thereby improving risk warning efficiency. In an embodiment, the preset data quantity may be 1, that is, high-risk warning is issued whenever any one piece of risk data satisfies a corresponding high-risk warning condition, thereby ensuring intelligent driving safety.

The risk assessment model is used to assess a risk level of corresponding risk data, and may be a logical model, a neural network model, or the like. The specific type may be determined according to actual conditions and is not limited in this embodiment. For example, if a risk item is acceleration, the risk assessment model may determine whether the acceleration is higher than a preset acceleration threshold. If the acceleration is greater than the preset acceleration threshold, it is determined that the first vehicle has an intelligent driving risk; otherwise, it is determined that the first vehicle does not have an intelligent driving risk. As another example, if a risk item is environmental perception information, the risk assessment model may be a binary classification model. The binary classification model extracts feature information from the environmental perception information and calculates, based on the feature information, a confidence level that the first vehicle has an intelligent driving risk. When the confidence level is higher than a preset confidence threshold, a classification result indicating that the first vehicle has an intelligent driving risk is output; otherwise, a classification result indicating that the first vehicle does not have an intelligent driving risk is output.

The intelligent driving risk warning information may be in the form of image, text, audio, or the like. For example, an image or text for the intelligent driving risk warning may be output through a display on the first vehicle, or audio for the intelligent driving risk warning may be output through a speaker on the first vehicle. The specific form may be determined according to actual conditions and is not limited in this embodiment.

In an embodiment, a human machine interface (HMI) reminder region may be provided on a display device on the first vehicle, and intelligent driving risk warning information may be output in the HMI reminder region together with guidance for risk removal. The HMI reminder region may be designed as a robot-like interactive text display or may be provided with dynamic interactive reminder graphics. Through more reasonable human-machine interaction, the driver can fully understand the actual condition of the intelligent driving system and has sufficient time to verify and remove risks, thereby making intelligent driving safer, more reliable, and more reassuring, and providing a better driving experience. At the same time, by designing a robot-like communicative intelligent driving interaction experience, the vehicle becomes more vivid, like a travel companion with life, and the human-machine combination is more sufficient, adapting to high-level intelligent driving.

As an example, step S30 includes: inputting the risk data into a preset risk assessment model; determining, through the preset risk assessment model and based on the risk data, whether the first vehicle has an intelligent driving risk; and in response to determining, by performing risk assessment based on the risk data through the preset risk assessment model, that the first vehicle has an intelligent driving risk, outputting intelligent driving risk warning information. In response to determining, by performing risk assessment based on the risk data through the preset risk assessment model, that the first vehicle does not have an intelligent driving risk, output of the intelligent driving risk warning information may be omitted, and the process may return to the step of acquiring vehicle driving information in response to determining that the first vehicle is in the intelligent driving state, so as to continuously monitor the first vehicle and ensure timeliness of the intelligent driving risk warning.

In an embodiment, if a preset number of target risk data satisfying preset high-risk warning conditions is detected from the risk data, operation prompt information for disengaging intelligent driving may also be output. For example, during steering, the operation for disengaging intelligent driving may be gripping the steering wheel firmly, and an image or video of firmly gripping the steering wheel may be output through the display on the first vehicle, or corresponding audio may be output through the speaker on the first vehicle. During acceleration, the operation for disengaging intelligent driving may be depressing the brake pedal, and a corresponding image, video, or audio may be output. During deceleration, the operation for disengaging intelligent driving may be depressing the accelerator pedal or pressing a button for releasing intelligent driving control, and a corresponding image, video, or audio may be output.

In an embodiment, since the first vehicle has different risk points in different driving states, the required risk data and the risk assessment models used are also different. For example, during acceleration, the risk points may focus on an inter-vehicle distance to a vehicle ahead and whether there is an intersection ahead; during deceleration, the risk points may focus on a vehicle speed of a following vehicle and whether a traffic participant suddenly cuts in or cuts out ahead. Therefore, different evaluation modes may be selected for different driving states of the first vehicle. Accordingly, a mapping relationship among driving states, risk items, and risk assessment models may be established in advance. In response to determining that the vehicle driving information satisfies the preset potential risk condition, the current target driving state of the first vehicle may be determined according to the vehicle driving information; target risk items and a target risk assessment model corresponding to the target driving state may be determined according to the preset mapping relationship among driving states, risk items, and risk assessment models; target risk items may be detected to obtain target risk data; and then risk assessment may be performed on the target risk data through the target risk assessment model.

The risk assessment model includes an overtaking lane-change risk assessment model, and the risk data further includes at least one of an overtaking lane-change command and steering speed. The step of performing risk assessment based on the risk data through the preset risk assessment model includes:
determining, through a preset overtaking lane-change risk assessment model, whether there are more than a fourth preset number of pieces of the risk data satisfying a preset overtaking lane-change risk warning condition, wherein the preset overtaking lane-change risk warning condition includes at least one of detecting an overtaking lane-change command and the steering speed exceeding a first preset steering speed threshold.

In this embodiment, the driving state of the first vehicle includes an overtaking lane-change state. The risk assessment model corresponding to the overtaking lane-change state is the overtaking lane-change risk assessment model. The risk data corresponding to the overtaking lane-change state includes at least one of an overtaking lane-change command and steering speed. Since safety risks during overtaking or lane changing are relatively high, for the overtaking lane-change state, it is only necessary to verify the accuracy of the overtaking lane-change state. Once it is determined that the vehicle is in the overtaking lane-change state, intelligent driving risk warning may be continuously performed. The overtaking lane-change command refers to an instruction issued by the intelligent driving system or a controller to control the vehicle to overtake or change lanes. The current overtaking lane-change state of the first vehicle may be verified either by detecting the overtaking lane-change command and/or by determining whether the steering speed exceeds the first preset steering speed threshold.

As an example, the overtaking lane-change command and/or the steering speed is input into the preset overtaking lane-change risk assessment model. Through the preset overtaking lane-change risk assessment model, it is determined whether the input contains an overtaking lane-change command and whether the input steering speed exceeds the first preset steering speed threshold. If an overtaking lane-change command is detected in the input, it is determined that the overtaking lane-change command satisfies the overtaking lane-change risk warning condition; otherwise, it does not satisfy the overtaking lane-change risk warning condition. If the steering speed exceeds the first preset steering speed threshold, it is determined that the steering speed satisfies the preset overtaking lane-change risk warning condition; otherwise, it does not satisfy the preset overtaking lane-change risk warning condition. A quantity of pieces of risk data satisfying the preset overtaking lane-change risk warning condition is determined, and whether that quantity is greater than or equal to the fourth preset number is determined.

The risk assessment model includes an acceleration risk assessment model, and the risk data further includes at least one of host vehicle acceleration and first external environment information. The step of performing risk assessment based on the risk data through the preset risk assessment model includes:
determining, through the acceleration risk assessment model, whether there are more than a first preset number of pieces of the risk data satisfying a preset acceleration risk warning condition, wherein the preset acceleration risk warning condition includes at least one of: the perception confidence exceeding a first preset perception confidence threshold; the fusion confidence exceeding a first preset fusion confidence threshold; the host vehicle acceleration exceeding a first preset acceleration threshold; and recognizing, based on the first external environment information, at least one intersection within a first preset distance range ahead of the first vehicle.

In this embodiment, the risk data includes acceleration risk data. The acceleration risk data refers to data that may cause the first vehicle to generate a risk in an acceleration state, and may include one or more of host vehicle state information, external environment information, and intelligent driving verification information. The host vehicle state information refers to state information of the first vehicle, including host vehicle acceleration, steering wheel angle, and the like. For example, if an acceleration sensor, a vehicle speed sensor, or the like is abnormal or data transmission is delayed, an intelligent driving decision such as excessive host vehicle acceleration or relatively high host vehicle acceleration during a sharp turn may easily cause a safety accident. The external environment information refers to information of the environment in which the first vehicle is located, including road condition information, lane reference lines, obstacle information, and the like, wherein the obstacles include pedestrians, traffic facilities, and vehicles other than the first vehicle, and the obstacle information includes obstacle positions, obstacle speeds, and the like. When the intelligent driving decision violates environmental safety intention, for example, where an intersection is not far ahead or there is a sharp turn, continued acceleration may easily cause a safety accident. The intelligent driving verification information refers to information related to verifying the accuracy of the intelligent driving decision, including perception confidence, evaluated by each perception module itself, of independently perceived external environment information, fusion confidence representing deviations among perception capabilities of the respective perception modules, sensor precision, and the like. For example, where radar and a camera are deployed on the vehicle and there are a pedestrian and a truck ahead, the truck may pass in front of the pedestrian and occlude the pedestrian, resulting in the pedestrian not being detected at a certain moment. If the intelligent driving system controls the vehicle to accelerate based on perception data that fails to detect the pedestrian, a safety accident may result. Where camera data transmission or image recognition is delayed, the position of the pedestrian perceived by the camera may differ greatly from the position of the pedestrian perceived by the radar. In such a case, if the intelligent driving system controls the vehicle to accelerate based on the position of the pedestrian perceived by the camera, a safety accident may result. The perception accuracy of the perception modules is an important factor affecting intelligent driving decisions. However, environmental perception technology, sensor precision, data transmission delay, and the like may all affect the perception accuracy of the perception modules with respect to the external environment, thereby affecting the accuracy of intelligent driving decisions.

Different pieces of risk data correspond to different acceleration risk warning conditions. The acceleration risk warning condition corresponding to the perception confidence is that the perception confidence exceeds the first preset perception confidence threshold; the acceleration risk warning condition corresponding to the fusion confidence is that the fusion confidence exceeds the first preset fusion confidence threshold; the acceleration risk warning condition corresponding to the host vehicle acceleration is that the host vehicle acceleration exceeds the first preset acceleration threshold; and the acceleration risk warning condition corresponding to the first external environment information is that, based on the first external environment information, at least one intersection is recognized within the first preset distance range ahead of the first vehicle.

As an example, through the acceleration risk assessment model, it is determined whether the respective pieces of risk data satisfy their corresponding acceleration risk warning conditions, and then it is determined whether the number of pieces of risk data satisfying the preset acceleration risk warning condition is at least the first preset number.

The risk assessment model includes a deceleration risk assessment model, and the risk data further includes host vehicle deceleration. The step of performing risk assessment based on the risk data through the preset risk assessment model includes:
determining, through the deceleration risk assessment model, whether there are more than a second preset number of pieces of the risk data satisfying a preset deceleration risk warning condition, wherein the preset deceleration risk warning condition includes at least one of: the perception confidence exceeding a second preset perception confidence threshold, the fusion confidence exceeding a second preset fusion confidence threshold, and the host vehicle deceleration exceeding a first preset deceleration threshold.

In this embodiment, the deceleration risk data refers to data that may cause the first vehicle to generate a risk in a deceleration state, and may include one or more of host vehicle state information, external environment information, and intelligent driving verification information. The host vehicle state information refers to state information of the first vehicle, including host vehicle deceleration, steering wheel angle, and the like. For example, if a deceleration sensor, a vehicle speed sensor, or the like is abnormal or data transmission is delayed, an intelligent driving decision such as excessive host vehicle deceleration or relatively high host vehicle deceleration during a sharp turn may easily cause a safety accident. Moreover, scenarios with relatively large host vehicle deceleration are themselves relatively risky. For example, when another vehicle suddenly cuts in ahead, a larger host vehicle deceleration is required to avoid colliding with the cut-in vehicle. As another example, during car-following, a leading vehicle may suddenly cut out to avoid colliding with a pedestrian ahead. If the pedestrian had been occluded by the leading vehicle and was not recognized by the subject vehicle during the car-following process, then after the leading vehicle cuts out, the subject vehicle needs a relatively large host vehicle deceleration to avoid hitting the pedestrian ahead. In these scenarios involving relatively large host vehicle deceleration, if the first vehicle exits the intelligent driving state due to a system fault or the like during deceleration and the deceleration control instruction is interrupted so that the first vehicle no longer decelerates, and if the driver's attention is not focused on the vehicle operation, the driver may fail to notice the abnormality of the vehicle and may not have enough time to brake after eventually noticing it. Therefore, the collision risk is relatively high. If a deceleration risk warning is issued upon entering such scenarios, the driver can prepare in advance to take over the vehicle and focus attention on determining whether the vehicle driving state is reasonable. In this way, when an abnormal driving state violating the driver's intention or environmental safety intention occurs due to a system fault, the driver can take over the vehicle more quickly and more timely, thereby reducing safety risk. The external environment information refers to information of the environment in which the first vehicle is located, including road condition information, lane reference lines, obstacle information, and the like, wherein the obstacles include pedestrians, traffic facilities, and vehicles other than the first vehicle, and the obstacle information includes obstacle positions, obstacle speeds, and the like. When the intelligent driving decision violates environmental safety intention, for example, where the vehicle is currently traveling on a highway, a following vehicle has a relatively high speed, and the distance between the following vehicle and the subject vehicle is relatively small, continued deceleration may easily cause a safety accident. The intelligent driving verification information refers to information related to verifying the accuracy of the intelligent driving decision, including perception confidence, evaluated by each perception module itself, of independently perceived external environment information, fusion confidence representing deviations among perception capabilities of the respective perception modules, sensor precision, and the like. For example, radar and a camera are deployed on the vehicle. At the right rear side there is a truck traveling relatively slowly, and behind the truck there is a passenger vehicle traveling at high speed and intending to change lanes. During some periods, the truck occludes the passenger vehicle, which may result in failure to detect the passenger vehicle at a certain moment or failure to recognize its lane-changing intention. In such a case, a deceleration decision made by the intelligent driving system may cause a safety accident. Where camera data transmission or image recognition is delayed, the position of an obstacle vehicle perceived by the camera may differ greatly from the position of a pedestrian perceived by the radar. In such a case, if the intelligent driving system controls the vehicle to decelerate based on the position of the pedestrian perceived by the camera, a safety accident may result. The perception accuracy of the perception modules is an important factor affecting intelligent driving decisions. However, environmental perception technology, sensor precision, data transmission delay, and the like may all affect the perception accuracy of the perception modules with respect to the external environment, thereby affecting the accuracy of intelligent driving decisions.

Different pieces of risk data correspond to different deceleration risk warning conditions. The deceleration risk warning condition corresponding to the perception confidence is that the perception confidence exceeds the second preset perception confidence threshold; the deceleration risk warning condition corresponding to the fusion confidence is that the fusion confidence exceeds the second preset fusion confidence threshold; and the deceleration risk warning condition corresponding to the host vehicle deceleration is that the host vehicle deceleration exceeds the first preset deceleration threshold.

As an example, through the deceleration risk assessment model, it is determined whether the respective pieces of risk data satisfy their corresponding deceleration risk warning conditions, and then it is determined whether the number of pieces of risk data satisfying the preset deceleration risk warning condition is at least the second preset number.

The risk assessment model includes a steering risk assessment model, and the risk data further includes at least one of road information, environmental perception data, and an actual steering direction. The step of performing risk assessment based on the risk data through the preset risk assessment model includes:
acquiring an intelligent-driving-designated steering direction; and
determining, through the steering risk assessment model, whether there are more than a third preset number of pieces of the risk data satisfying a preset steering risk warning condition, wherein the preset steering risk warning condition includes at least one of: the perception confidence exceeding a third preset perception confidence threshold; the fusion confidence exceeding a third preset fusion confidence threshold; recognizing, based on the environmental perception data, at least one target object within a second preset distance range on left and right sides of the first vehicle; recognizing, based on the road information, at least one steering-risk road segment within a third preset distance range from the first vehicle; and the actual steering direction being different from the intelligent-driving-designated steering direction, wherein the steering-risk road segment includes at least one of an intersection, a complex lane line road segment, and a sharp-turn road segment.

In this embodiment, the steering risk data refers to data that may cause the first vehicle to generate a risk in a steering state, and may include one or more of host vehicle state information, environmental perception information, and intelligent driving verification information. The host vehicle state information refers to state information of the first vehicle, including steering speed, vehicle speed, and the like. For example, if a steering speed sensor, a vehicle speed sensor, or the like is abnormal or data transmission is delayed, an intelligent driving decision such as excessive steering speed or excessive steering angle may easily cause a safety accident. The environmental perception information refers to information of the environment in which the first vehicle is located, including road information, lane reference lines, obstacle information, and the like, wherein the obstacles include pedestrians, traffic facilities, and vehicles other than the first vehicle, and the obstacle information includes obstacle positions, obstacle speeds, and the like. When the intelligent driving decision violates environmental safety intention, for example, where an intersection is not far ahead or the vehicle is currently at a sharp turn, inaccurate steering timing or an excessively large or small steering angle may easily cause a collision accident. The intelligent driving verification information refers to information related to verifying the accuracy of the intelligent driving decision, including perception confidence, evaluated by each perception module itself, of independently perceived external environment information, fusion confidence representing deviations among perception capabilities of the respective perception modules, sensor precision, and the like. For example, radar and a camera are deployed on the vehicle. The vehicle actually needs to turn right at an intersection ahead, but there is a pedestrian crossing at the intersection. During some periods, the pedestrian may be occluded by other vehicles or pedestrians and cannot be detected. If the intelligent driving system controls the vehicle to steer based on perception data that fails to detect the pedestrian, a safety accident may result. Where camera data transmission or image recognition is delayed, the position of the pedestrian perceived by the camera may differ greatly from the position of the pedestrian perceived by the radar. In such a case, if the intelligent driving system controls the vehicle to steer based on the position of the pedestrian perceived by the camera, a safety accident may result. The perception accuracy of the perception modules is an important factor affecting intelligent driving decisions. However, environmental perception technology, sensor precision, data transmission delay, and the like may all affect the perception accuracy of the perception modules with respect to the external environment, thereby affecting the accuracy of intelligent driving decisions.

The road information refers to road information within a certain range from the first vehicle, and may include road type, road width, lane width, and the like. The detection of the road information may be determined according to a high-definition map and positioning information, or may be perceived by the perception modules on the first vehicle.

The environmental perception data refers to information of the environment in which the first vehicle is located as perceived by the perception modules on the first vehicle, including road condition information, lane reference lines, obstacle information, and the like, wherein the obstacles include pedestrians, traffic facilities, and vehicles other than the first vehicle, and the obstacle information includes obstacle positions, obstacle speeds, and the like. The environmental perception data may be provided by the perception modules. For example, it may be an external environment image captured by a camera, or an external environment model generated after combining information from multiple perception modules such as cameras and radars. The specific form may be determined according to actual conditions and is not limited in this embodiment. The external environment has a relatively large effect on driving safety. When the intelligent driving decision violates environmental safety intention, for example, where there are other vehicles in the left and right side lanes or vehicles merging at an intersection ahead, inaccurate steering timing or an excessively large or small steering angle may easily cause a collision accident.

The actual steering direction refers to a direction in which a steering controller of the first vehicle controls the first vehicle to steer, and may be detected through a steering direction sensor. The intelligent-driving-designated steering direction refers to a steering direction in a steering decision made by the intelligent driving system. After making the steering decision, the intelligent driving system sends a control instruction to the controller. However, opposite steering directions in control instructions may be represented by positive and negative signs, for example, right as positive and left as negative. Thus, before the controller issues a final control instruction, the final control instruction may differ from the steering decision made by the intelligent driving system due to data transmission delay, system fault, or the like. For example, the road ahead is actually a right turn, but the control instruction issued by the controller is to steer left. If the driver waits until feeling that the vehicle has gone in the wrong direction before correcting the vehicle, in some road conditions with insufficient reaction time, collision with a curb may already be unavoidable. Most vehicles are currently equipped with a steering direction sensor that can sense the actual steering direction of the vehicle, while the intelligent-driving-designated steering direction has already been generated when the intelligent driving system makes the decision. Therefore, the actual steering direction and the intelligent-driving-designated steering direction can be obtained quickly and simply, and comparing them can quickly verify correctness of the steering direction. This is a low-cost and effective way to improve intelligent driving safety.

Different pieces of risk data correspond to different steering risk warning conditions. The steering risk warning condition corresponding to the perception confidence is that the perception confidence exceeds the third preset perception confidence threshold. The steering risk warning condition corresponding to the fusion confidence is that the fusion confidence exceeds the third preset fusion confidence threshold. The steering risk warning condition corresponding to the environmental perception data is that, based on the environmental perception data, at least one target object is recognized within the second preset distance range on the left and right sides of the first vehicle. The steering risk warning condition corresponding to the road information is that, based on the road information, at least one steering-risk road segment is recognized within the third preset distance range from the first vehicle. The steering risk warning condition corresponding to the steering direction is that the actual steering direction is different from the intelligent-driving-designated steering direction.

The steering-risk road segment includes at least one of an intersection, a complex lane line road segment, and a sharp-turn road segment. The intersection includes merge-in traffic conditions and merge-out traffic conditions. The complex lane line road segment refers to a road segment where lane lines differ from reasonable lane lines. For example, reasonable lane lines may mean lane lines having a correct lane width and one solid line or dashed line on each side, or line characteristics conforming to normal traffic regulations. However, due to detours, road repair, and the like, three or more lane lines may sometimes be recognized, and a distance between any two adjacent lane lines is not equal to a lane width. The sharp-turn road segment refers to a road segment with a curve radius smaller than a preset radius threshold. The curve radius may be determined according to a high-definition map and positioning information, or may be perceived by the perception modules on the first vehicle. In an embodiment, the sharp-turn road segment may refer to a curve having a radius smaller than 250 m. The current or upcoming road segment of the first vehicle has a relatively large effect on driving safety. When the intelligent driving decision violates environmental safety intention, for example, where an intersection is not far ahead, the lane lines of the current road are complex, or the vehicle is currently at a sharp turn, the intelligent driving decision may easily become inaccurate, and inaccurate steering timing or an excessively large or small steering angle may easily cause a collision accident.

As an example, through the steering risk assessment model, it is determined whether the respective pieces of risk data satisfy their corresponding steering risk warning conditions, and then it is determined whether the number of pieces of risk data satisfying the preset steering risk warning condition is at least the third preset number.

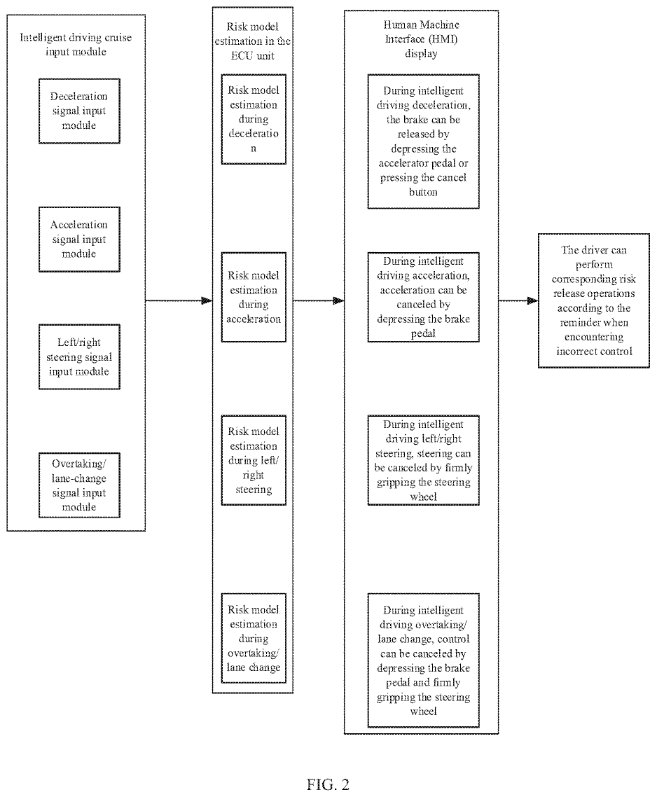

In an embodiment, with reference to FIG. 2, the intelligent driving risk warning apparatus includes an input module deployed in an intelligent driving cruising system, a risk model deployed in an electronic control unit (ECU), and a human-machine interaction display module. The input module includes a deceleration-state signal input module, an acceleration-state signal input module, a left/right steering-state signal input module, and an overtaking/lane-changing signal input module, respectively configured to receive vehicle driving information. When the vehicle driving information input into any one or more of the input modules satisfies the preset potential risk condition, risk data is detected, and the risk model performs risk estimation for deceleration, acceleration, left/right steering, and overtaking/lane changing based on the risk data. Further, when any one or more target risk models estimate that the first vehicle has an intelligent driving risk, the human-machine interaction display module outputs intelligent driving risk warning information corresponding to the target risk model. For example, where there is an intelligent driving risk during deceleration, intelligent driving risk warning information such as “Intelligent driving is decelerating; you may depress the accelerator pedal or press the cancel button to release braking” may be output. Where there is an intelligent driving risk during acceleration, intelligent driving risk warning information such as “Intelligent driving is accelerating; you may depress the brake pedal to cancel acceleration” may be output. Where there is an intelligent driving risk during left/right steering, intelligent driving risk warning information such as “Intelligent driving is steering left/right; you may firmly grip the steering wheel to cancel steering” may be output. Where there is an intelligent driving risk during overtaking/lane changing, intelligent driving risk warning information such as “Intelligent driving is overtaking/changing lane; you may depress the brake pedal and firmly grip the steering wheel to release control” may be output.

In this embodiment, the intelligent driving risk warning method is applied to the first vehicle having an intelligent driving function. First, by acquiring vehicle driving information in response to determining that the first vehicle is in the intelligent driving state, monitoring of the first vehicle in the intelligent driving state is achieved. Further, by performing risk data detection in response to determining that the vehicle driving information satisfies the preset potential risk condition, risk monitoring is achieved when the first vehicle has a potential risk. Further, by outputting intelligent driving risk warning information in response to determining, by performing risk assessment based on the risk data through the preset risk assessment model, that the first vehicle has an intelligent driving risk, timely risk warning is achieved. In this way, if an intelligent driving decision violates the driver's intention or environmental safety intention due to system limitations, a human driver, after receiving the intelligent driving risk warning information, can make a timely judgment and intervene to control the vehicle, thereby avoiding risks. Therefore, the technical defect is overcome that the intelligent driving system itself may make erroneous decisions due to precision limitations, errors, and the like, thereby performing incorrect actions or losing control actions, such that the system limitations still present a relatively high safety risk. Thus, safety vulnerabilities of intelligent driving attributable to system limitations are compensated for, and safety during the intelligent driving process is improved.

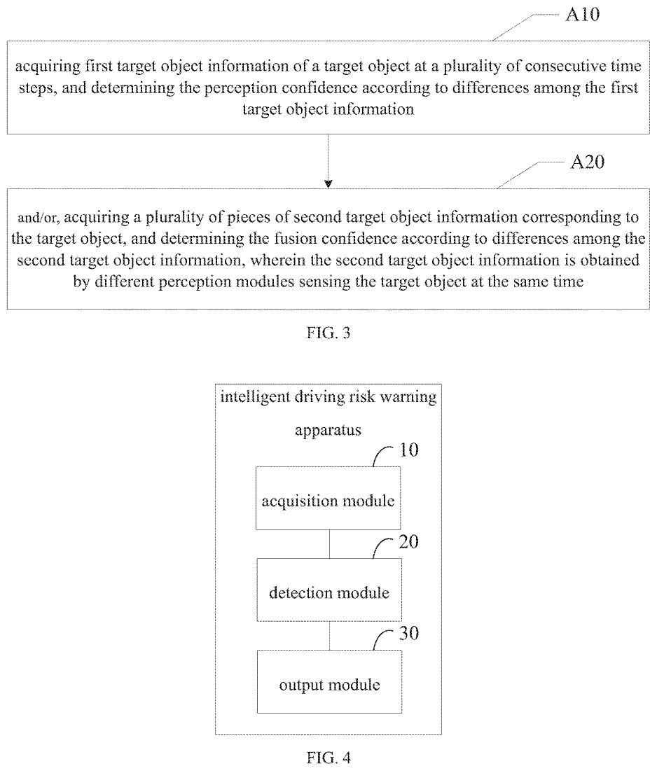

With reference to FIG. 3, based on the above embodiments of the present application, in a second embodiment of the present application, for content identical or similar to the above embodiments, reference may be made to the foregoing description and details are not repeated. On this basis, the risk data includes at least one of perception confidence and fusion confidence. The step of performing risk data detection includes:

Step A10, acquiring first target object information of a target object at a plurality of consecutive time steps, and determining the perception confidence according to differences among the first target object information.

In this embodiment, the first vehicle further includes an intelligent driving system. The intelligent driving system includes at least one perception module, such as a radar, a camera, or the like. Each perception module independently perceives a target object in the external environment and generates target object information, so that the intelligent driving system can make an intelligent driving decision based on the target object information. However, because systematic errors of perception technology, sensor precision, data transmission delay, and the like may all affect the accuracy of intelligent driving decisions made by the intelligent driving system, when the change in vehicle travel direction and speed is small and road conditions are good, the intelligent driving system itself may timely correct an earlier erroneous decision. However, the greater the vehicle speed, acceleration, deceleration, or steering speed of the first vehicle, the greater the change occurring in the vehicle within a short period of time, and the greater the effect of deviation of the intelligent driving decision on driving safety. Before the intelligent driving system corrects its erroneous decision, a safety accident may already occur, resulting in a relatively high safety risk.

There may be one or more target objects around the first vehicle. The target object may refer to any one target object, or may refer to any target object identified by the perception modules as contributing to the intelligent driving decision of the first vehicle. For each target object, step A10 may be separately performed to detect and determine perception confidence, or step A20 may be separately performed to detect and determine fusion confidence.

The first target object information refers to a recognition result of the perception module for the target object, and may include at least one of detection information, category, speed, and size of the target object, wherein the detection information indicates whether the target object is recognized. The target object includes obstacles, traffic facilities, road reference lines, and the like.

Target lane line information refers to a recognition result of the perception module for a target lane line, and may include at least one of detection information, category, and size of the target lane line, wherein the detection information indicates whether the target lane line is recognized.

A step length of the time steps may be set according to actual conditions, for example, 100 ms, 200 ms, 400 ms, and the like, and is not limited in this embodiment. In an embodiment, the plurality of consecutive time steps may include a current time step and/or a time step used for making an intelligent driving control decision. The first target object information at the current time step may be used to determine current perception stability and accuracy, and the first target object information at the time step used for making the intelligent driving control decision may be used to determine the accuracy of the intelligent driving control decision.

The perception confidence is used to characterize changes in perception results of the perception module for the target object and the target lane line during a process of tracking the target object over a period of time. For example, a target object is originally recognizable, then suddenly lost, then suddenly recognized again, repeatedly; a target lane line is originally recognizable, then suddenly lost, then suddenly recognized again, repeatedly; a category of the recognized target object changes abruptly from A at a previous time step to B at a subsequent time step; a category of the recognized target lane line changes abruptly from C at a previous time step to D at a subsequent time step; a speed of the recognized target object changes abruptly from stationary to greater than 30 km/h, or suddenly changes from greater than 30 km/h to stationary; a size of the recognized target object suddenly becomes larger or smaller with a ratio difference reaching 1.5 times; and the like. In these cases, it indicates that the stability and accuracy of the perception module during that period may be relatively low. Continued intelligent driving may present a relatively high safety risk, and therefore intelligent driving risk warning needs to be performed to remind the driver to pay attention to vehicle dynamics and decide whether to intervene in vehicle control.

In an embodiment, the perception confidence may be calculated based on first target object information over multiple time steps and/or target lane line information. For example, pairwise differences may be calculated among the first target object information over multiple time steps, and then an average value, median value, maximum value, or the like of the differences may be used as the perception confidence corresponding to the target object. Pairwise differences may also be calculated among the target lane line information over multiple time steps, and then an average value, median value, maximum value, or the like of the differences may be used as the perception confidence corresponding to the target lane line. In this case, a preset perception suspiciousness threshold may be determined according to empirical values, vehicle calibration results, and the like, and is not limited in this embodiment.

In another embodiment, the perception confidence may be assigned based on differences among the first target object information over multiple time steps and/or differences among the target lane line information over multiple time steps. For example, if the first target object information over multiple time steps is identical, or a difference, variance, or the like is smaller than a preset threshold, it indicates that the perception stability and accuracy of the perception module are relatively high and no abrupt change has occurred; therefore, the perception confidence is assigned a value of 0. If the first target object information over multiple time steps is different, or a difference, variance, or the like exceeds the preset threshold, it indicates that the perception stability and accuracy of the perception module are relatively low and an abrupt change has occurred; therefore, the perception confidence is assigned a value of 1. In this case, the preset perception suspiciousness threshold may be set to 0.

As an example, step A10 includes: acquiring, from the perception module or a corresponding memory, first target object information over a plurality of consecutive time steps, for example, first target object information at a current time step and N1 time steps prior to the current time step, or first target object information from a time step used for making an intelligent driving control decision to the current time step; and then determining the perception confidence according to differences among the first target object information.

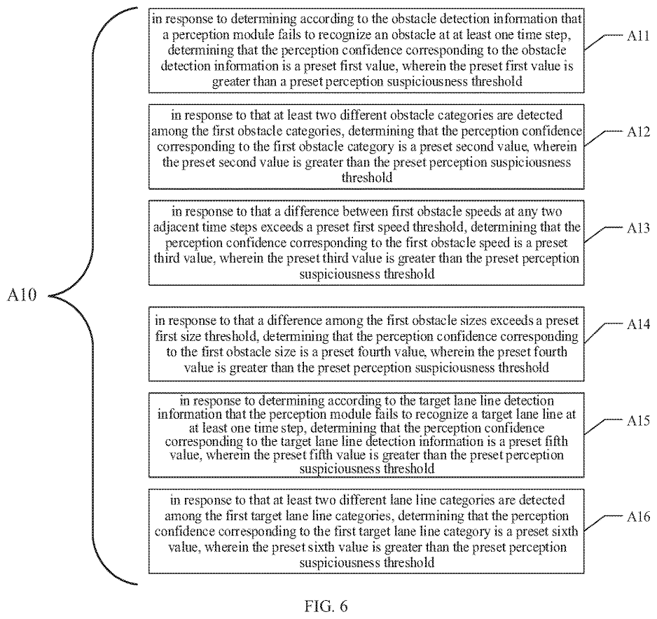

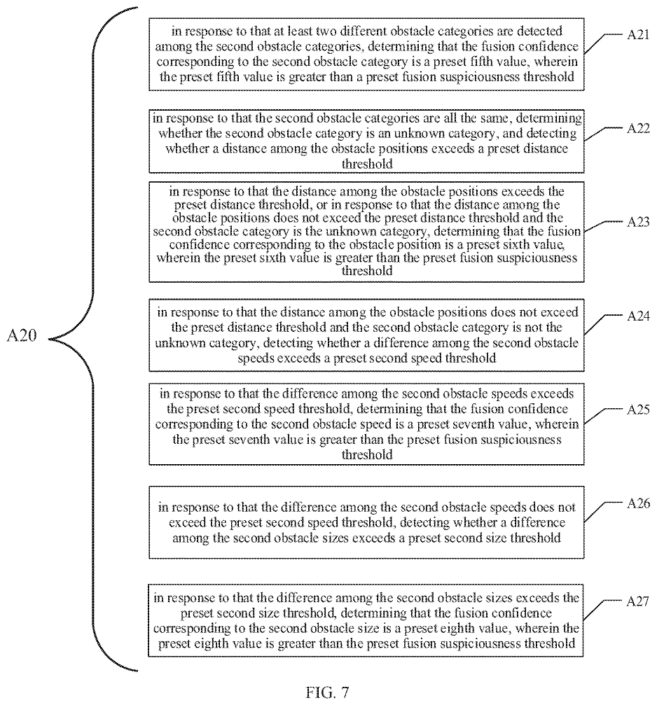

With reference to FIG. 6, in one embodiment, the first target object information includes at least one of obstacle detection information, a first obstacle category, a first obstacle speed, a first obstacle size, target lane line detection information, and a target lane line category. The step of determining the perception confidence according to differences among the first target object information includes:

Step A11: in response to determining according to the obstacle detection information that a perception module fails to recognize an obstacle at at least one time step, determining that the perception confidence corresponding to the obstacle detection information is a first preset value, wherein the first preset value is greater than a preset perception suspiciousness threshold.

As an example, step A11 includes: determining whether the respective pieces of obstacle detection information all indicate recognition of the target object; and if at least one of the obstacle detection information does not indicate recognition of the target object, determining that the perception module failed to recognize the obstacle at at least one time step, that is, the perception module lost the target during that period, has relatively low stability, and presents a relatively high safety risk. Therefore, the perception confidence corresponding to the obstacle detection information may be determined to be the first preset value higher than the preset perception suspiciousness threshold, wherein the first value, second value, third value, fourth value, fifth value, and sixth value may be the same as or different from one another, and are not limited in this embodiment.

Step A12: and/or, in response to that at least two different obstacle categories are detected among the first obstacle categories, determining that the perception confidence corresponding to the first obstacle category is a second preset value, wherein the second preset value is greater than the preset perception suspiciousness threshold.

As an example, step A12 includes: comparing the first obstacle categories to determine whether they are identical; and if at least two different obstacle categories are present among the first obstacle categories, determining that the perception module has relatively low stability during that period and presents a relatively high safety risk. Therefore, the perception confidence corresponding to the first obstacle categories may be determined to be the second preset value higher than the preset perception suspiciousness threshold.

Step A13: and/or, in response to that a difference between first obstacle speeds at any two adjacent time steps exceeds a first preset speed threshold, determining that the perception confidence corresponding to the first obstacle speed is a third preset value, wherein the third preset value is greater than the preset perception suspiciousness threshold.

As an example, step A13 includes: sequentially comparing first obstacle speeds at two adjacent time steps, calculating a difference, and determining whether the difference exceeds the first preset speed threshold; and if a difference between first obstacle speeds at any two adjacent time steps exceeds the first preset speed threshold, determining that the perception module has relatively low stability during that period and presents a relatively high safety risk. Therefore, the perception confidence corresponding to the first obstacle speed may be determined to be the third preset value higher than the preset perception suspiciousness threshold.

Step A14: and/or, in response to that a difference among the first obstacle sizes exceeds a first preset size threshold, determining that the perception confidence corresponding to the first obstacle size is a fourth preset value, wherein the fourth preset value is greater than the preset perception suspiciousness threshold.

As an example, step A14 includes: calculating pairwise differences among the first obstacle sizes, or sequentially comparing first obstacle sizes at two adjacent time steps and calculating a difference, and then comparing the difference with the first preset size threshold to determine whether the difference exceeds the first preset size threshold; and if differences among the first obstacle sizes exceed the first preset size threshold, determining that the perception module has relatively low stability during that period and presents a relatively high safety risk. Therefore, the perception confidence corresponding to the first obstacle size may be determined to be the fourth preset value higher than the preset perception suspiciousness threshold.

Step A15: and/or, in response to determining according to the target lane line detection information that the perception module fails to recognize a target lane line at at least one time step, determining that the perception confidence corresponding to the target lane line detection information is a fifth preset value, wherein the fifth preset value is greater than the preset perception suspiciousness threshold.

As an example, step A15 includes: determining whether the respective pieces of target lane line detection information all indicate recognition of the target lane line; and if at least one of the target lane line detection information does not indicate recognition of the target lane line, determining that the perception module failed to recognize the target lane line at at least one time step, that is, the perception module lost the target during that period, has relatively low stability, and presents a relatively high safety risk. Therefore, the perception confidence corresponding to the target lane line detection information may be determined to be the fifth preset value higher than the preset perception suspiciousness threshold.

Step A16: and/or, in response to that at least two different lane line categories are detected among the first target lane line categories, determining that the perception confidence corresponding to the first target lane line category is a sixth preset value, wherein the sixth preset value is greater than the preset perception suspiciousness threshold.

As an example, step A16 includes: comparing the first target lane line categories to determine whether they are identical; and if at least two different lane line categories are present among the first target lane line categories, determining that the perception module has relatively low stability during that period and presents a relatively high safety risk. Therefore, the perception confidence corresponding to the first target lane line categories may be determined to be the sixth preset value higher than the preset perception suspiciousness threshold.

In this embodiment, by comparing and verifying the first target object information perceived by the perception module over multiple time steps, if differences among the first target object information over multiple time steps are small, it indicates that the perception module is relatively stable and accurate during that period; if differences among the first target object information over multiple time steps are large, it indicates that the confidence of the perception module during that period is relatively low. Therefore, intelligent driving risk warning needs to be performed to remind the driver to pay attention to the dynamics of the first vehicle, thereby avoiding erroneous intelligent driving decisions caused by sudden system faults and improving intelligent driving safety.

Step A20, and/or, acquiring a plurality of pieces of second target object information corresponding to the target object, and determining the fusion confidence according to differences among the second target object information, wherein the second target object information is obtained by different perception modules sensing the target object at the same time.

In this embodiment, the second target object information refers to recognition results obtained when different perception modules independently recognize the target object at a specified time, and may include at least one of category, speed, position, and size of the target object, wherein the specified time may be the current time or a time used for making an intelligent driving control decision.

Where the intelligent driving system includes multiple perception modules, after each perception module independently performs perception, the intelligent driving system needs to fuse perception results of the respective perception modules to obtain a fusion result. If one perception module has an inaccurate perception result due to system limitations, that result will differ significantly from perception results of the other perception modules. In this case, the fusion result becomes inaccurate due to the influence of the inaccurate perception result, thereby leading to an inaccurate intelligent driving decision. The fusion confidence is used to characterize differences among perception results of the target object obtained by the plurality of perception modules at the same time. For example, the perception modules include a radar and a camera, the radar recognizes the category of the target object as a pedestrian, while the camera recognizes the category of the target object as a vehicle; both the radar and the camera recognize the category of the target object as a vehicle, but a position of the target object recognized by the radar differs from a position of the target object recognized by the camera by more than 30 cm; the radar and the camera recognize the same position of the target object, but both recognize the type as an unknown category; both the radar and the camera recognize the category of the target object as a vehicle and recognize the same position, but a speed of the target object recognized by the radar differs from a speed of the target object recognized by the camera by more than 10 km/h; both the radar and the camera recognize the category of the target object as a vehicle and recognize the same position and speed, but a size of the target object recognized by the radar is 1.5 times a size of the target object recognized by the camera; and the like. In these cases, it indicates that stability and accuracy of at least one perception module during that period may be relatively low. Continued intelligent driving may present a relatively high safety risk, and therefore intelligent driving risk warning needs to be performed to remind the driver to pay attention to vehicle dynamics and decide whether to intervene in vehicle control.

In an embodiment, the fusion confidence may be calculated based on the second target object information. For example, pairwise differences may be calculated among the second target object information, and an average value, median value, maximum value, or the like of the differences may be used as the fusion confidence. In this case, a preset fusion suspiciousness threshold may be determined according to empirical values, vehicle calibration results, and the like, and is not limited in this embodiment.

In another embodiment, the fusion confidence may be assigned based on differences among the second target object information. For example, if the second target object information is identical, or a difference, variance, or the like is smaller than a preset threshold, it indicates that the confidence of the respective perception modules is relatively high, and therefore the fusion confidence is assigned 0. If the second target object information is different, or a difference, variance, or the like exceeds the preset threshold, it indicates that confidence of at least one perception module is relatively low, and therefore the fusion confidence is assigned a value of 1. In this case, the preset perception suspiciousness threshold may be set to 0.

As an example, step A20 includes: acquiring, from the perception modules or corresponding memories, second target object information of the target object at a specified time, for example, current second target object information or second target object information at a time used for making an intelligent driving control decision; and then determining the fusion confidence according to differences among the second target object information.

With reference to FIG. 7, in one embodiment, the second target object information includes at least one of a second obstacle category, obstacle position, a second obstacle speed, and a second obstacle size. The step of determining the fusion confidence according to differences among the second target object information includes:

Step A21: in response to that at least two different obstacle categories are detected among the second obstacle categories, determining that the fusion confidence corresponding to the second obstacle category is a fifth preset value, wherein the fifth preset value is greater than a preset fusion suspiciousness threshold.

As an example, step A21 includes: comparing the second obstacle categories to determine whether they are identical; and if at least two different obstacle categories are present among the second obstacle categories, determining that confidence of at least one perception module is relatively low and a relatively high safety risk exists. Therefore, the fusion confidence corresponding to the second obstacle categories may be determined to be the fifth preset value higher than the preset fusion suspiciousness threshold, wherein the fifth value, sixth value, seventh value, and eighth value may be the same as or different from one another, and are not limited in this embodiment.

Step A22: in response to that the second obstacle categories are all the same, determining whether the second obstacle category is an unknown category, and detecting whether a distance among the obstacle positions exceeds a preset distance threshold.

Step A23: in response to that the distance among the obstacle positions exceeds the preset distance threshold, or in response to that the distance among the obstacle positions does not exceed the preset distance threshold and the second obstacle category is the unknown category, determining that the fusion confidence corresponding to the obstacle position is a sixth preset value, wherein the sixth preset value is greater than the preset fusion suspiciousness threshold.

As an example, steps A22-A23 include: after comparing the second obstacle categories to determine whether they are identical, if all the second obstacle categories are the same, determining whether the second obstacle category is an unknown category; pairwise comparing the obstacle positions and calculating distances between every two obstacle positions; comparing the distances between every two obstacle positions with the preset distance threshold to determine whether the distances exceed the preset distance threshold; and if the distances among the obstacle positions exceed the preset distance threshold, or if the distances among the obstacle positions do not exceed the preset distance threshold and the second obstacle category is the unknown category, determining that confidence of at least one perception module is relatively low and a relatively high safety risk exists. Therefore, the fusion confidence corresponding to the obstacle positions may be determined to be the sixth preset value higher than the preset fusion suspiciousness threshold.

Step A24: in response to that the distance among the obstacle positions does not exceed the preset distance threshold and the second obstacle category is not the unknown category, detecting whether a difference among the second obstacle speeds exceeds a second preset speed threshold.

Step A25: in response to that the difference among the second obstacle speeds exceeds the second preset speed threshold, determining that the fusion confidence corresponding to the second obstacle speed is a seventh preset value, wherein the seventh preset value is greater than the preset fusion suspiciousness threshold.

As an example, steps A24-A25 include: if the distances among the obstacle positions do not exceed the preset distance threshold and the second obstacle category is not the unknown category, calculating pairwise differences among the second obstacle speeds and determining whether the differences exceed the second preset speed threshold; and if a difference between any two second obstacle speeds exceeds the second preset speed threshold, determining that stability of at least one perception module is relatively low and a relatively high safety risk exists. Therefore, the fusion confidence corresponding to the second obstacle speeds may be determined to be the seventh preset value higher than the preset fusion suspiciousness threshold.

Step A26: in response to that the difference among the second obstacle speeds does not exceed the second preset speed threshold, detecting whether a difference among the second obstacle sizes exceeds a second preset size threshold.

Step A27: in response to that the difference among the second obstacle sizes exceeds the second preset size threshold, determining that the fusion confidence corresponding to the second obstacle size is a eighth preset value, wherein the eighth preset value is greater than the preset fusion suspiciousness threshold.

As an example, steps A26-A27 include: if differences among the second obstacle speeds do not exceed the second preset speed threshold, calculating pairwise differences among the second obstacle sizes and determining whether the differences exceed the second preset size threshold; and if a difference between any two second obstacle sizes exceeds the second preset size threshold, determining that stability of at least one perception module is relatively low and a relatively high safety risk exists. Therefore, the fusion confidence corresponding to the second obstacle sizes may be determined to be the eighth preset value higher than the preset fusion suspiciousness threshold.

In this embodiment, by comparing and verifying the second target object information perceived by the plurality of perception modules at the same time, if differences among the second target object information perceived by the plurality of perception modules at the same time are small, it indicates that the respective perception modules are relatively stable and accurate during that period; if differences among the second target object information perceived by the plurality of perception modules at the same time are large, it indicates that confidence of at least one perception module during that period is relatively low. Perception data with relatively low confidence will affect the intelligent driving decision made by the intelligent driving system, thereby presenting a relatively high safety risk. Therefore, intelligent driving risk warning needs to be performed to remind the driver to pay attention to the dynamics of the first vehicle, thereby avoiding erroneous intelligent driving decisions caused by sudden system faults and improving intelligent driving safety.

The embodiments of the present application further provide an intelligent driving risk warning apparatus. Referring to FIG. 4, the intelligent driving risk warning apparatus is applied to a first vehicle and includes an acquisition module 10, a detection module 20 and an output module 30.

The acquisition module 10 is configured to acquire vehicle driving information in response to determining that the first vehicle is in an intelligent driving state.

The detection module 20 is configured to perform risk data detection in response to determining that the vehicle driving information satisfies a preset potential risk condition.

The output module 30 is configured to output intelligent driving risk warning information in response to determining, by performing risk assessment based on the risk data through a preset risk assessment model, that the first vehicle has an intelligent driving risk.

The risk data includes at least one of a perception confidence and a fusion confidence. The detection module 20 is further configured to:
acquire first target object information of a target object at a plurality of consecutive time steps, and determine the perception confidence according to differences among the first target object information; and/or
acquire a plurality of pieces of second target object information corresponding to the target object, and determine the fusion confidence according to differences among the second target object information, wherein the second target object information is obtained by different perception modules sensing the target object at the same time.

The risk assessment model includes an acceleration risk assessment model, and the risk data further includes at least one of host vehicle acceleration and first external environment information. The output module 30 is further configured to:
determine, by the acceleration risk assessment model, whether more than a first preset number of items of the risk data satisfy a preset acceleration risk warning condition, wherein the preset acceleration risk warning condition includes at least one of: the perception confidence exceeding a first preset perception confidence threshold, the fusion confidence exceeding a first preset fusion confidence threshold, the host vehicle acceleration exceeding a first preset acceleration threshold, and identifying, based on the first external environment information, that at least one intersection exists within a first preset distance range ahead of the first vehicle.

The risk assessment model includes a deceleration risk assessment model, and the risk data further includes host vehicle deceleration. The output module 30 is further configured to:
determine, by the deceleration risk assessment model, whether more than a second preset number of items of the risk data satisfy a preset deceleration risk warning condition, wherein the preset deceleration risk warning condition includes at least one of: the perception confidence exceeding a second preset perception confidence threshold, the fusion confidence exceeding a second preset fusion confidence threshold, and the host vehicle deceleration exceeding a first preset deceleration threshold.

The risk assessment model includes a steering risk assessment model, and the risk data further includes at least one of road information, environmental perception data, and an actual steering direction. The output module 30 is further configured to:
acquire an intelligent-driving-designated steering direction; and
determine, by the steering risk assessment model, whether more than a third preset number of items of the risk data satisfy a preset steering risk warning condition, wherein the preset steering risk warning condition includes at least one of: the perception confidence exceeding a third preset perception confidence threshold, the fusion confidence exceeding a third preset fusion confidence threshold, identifying, based on the environmental perception data, that at least one target object exists within a second preset distance range on the left and right sides of the first vehicle, identifying, based on the road information, that at least one steering-risk road segment exists within a third preset distance range from the first vehicle, and the actual steering direction being different from the intelligent-driving-designated steering direction, wherein the steering-risk road segment includes at least one of an intersection, a complex lane line road segment, and a sharp-turn road segment.

The risk assessment model includes an overtaking lane-change risk assessment model, and the risk data further includes at least one of an overtaking lane-change command and a steering speed. The output module 30 is further configured to:
determine, by a preset overtaking lane-change risk assessment model, whether more than a fourth preset number of items of the risk data satisfy a preset overtaking lane-change risk warning condition, wherein the preset overtaking lane-change risk warning condition includes at least one of detecting the overtaking lane-change command and the steering speed exceeding a first preset steering speed threshold.

The vehicle driving information includes at least one of host vehicle acceleration, host vehicle deceleration, and steering speed. The detection module 20 is further configured to:
in response to detecting that target vehicle driving information satisfying the preset potential risk condition exists in the vehicle driving information, detect risk data corresponding to the target vehicle driving information, wherein the preset potential risk condition includes at least one of the host vehicle acceleration exceeding a second preset acceleration threshold, the host vehicle deceleration exceeding a second preset deceleration threshold, and the steering speed exceeding a second preset steering speed threshold.

The intelligent driving risk warning apparatus provided by the present application employs the intelligent driving risk warning method in the foregoing embodiments, thereby solving the technical problem in the related art that safety risks are relatively high during intelligent driving due to system limitations. Compared with the related art, the beneficial effects of the intelligent driving risk warning apparatus provided by the embodiments of the present application are the same as the beneficial effects of the intelligent driving risk warning method provided by the foregoing embodiments, and other technical features of the intelligent driving risk warning apparatus are the same as those disclosed for the method in the foregoing embodiments and will not be repeated herein.

An embodiment of the present application provides an electronic device. The electronic device includes: at least one processor; and a memory communicatively connected to the at least one processor. The memory stores instructions executable by the at least one processor, and the instructions, when executed by the at least one processor, enable the at least one processor to perform the intelligent driving risk warning method in the foregoing embodiments.

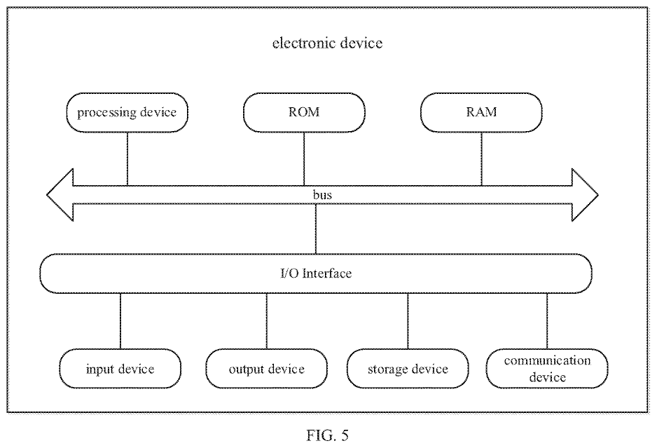

Referring now to FIG. 5, FIG. 5 shows a schematic structural diagram of an electronic device suitable for implementing the embodiments of the present application. The electronic device in the embodiments of the present application may include, but is not limited to, mobile terminals such as a Bluetooth headset, a mobile phone, a laptop computer, a digital broadcast receiver, a personal digital assistant (PDA), a tablet computer (PAD), a portable multimedia player (PMP), and a vehicle-mounted terminal (for example, a vehicle-mounted navigation terminal), as well as fixed terminals such as a digital TV and a desktop computer. The electronic device shown in FIG. 5 is merely an example and should not impose any limitation on the functions and scope of use of the embodiments of the present application.

As shown in FIG. 5, the electronic device may include a processing device (for example, a central processing unit, a graphics processing unit, etc.), which may execute various appropriate actions and processing according to a program stored in a read-only memory (ROM) or a program loaded from a storage device into a random-access memory (RAM). The RAM also stores various programs and data required for operation of the electronic device. The processing device, the ROM, and the RAM are connected to one another through a bus. An input/output (I/O) interface is also connected to the bus.

Generally, the following components may be connected to the I/O interface: an input device including, for example, a touch screen, a touch pad, a keyboard, a mouse, an image sensor, a microphone, an intelligent driving speedometer, a gyroscope, and the like; an output device including, for example, a liquid crystal display (LCD), a speaker, a vibrator, and the like; a storage device including, for example, magnetic tape, a hard disk, and the like; and a communication device. The communication device may allow the electronic device to communicate wirelessly or by wire with other devices to exchange data. Although the figure shows an electronic device having various components, it should be understood that it is not required to implement or include all of the illustrated components. Alternatively, more or fewer components may be implemented or included.

According to the embodiments of the present application, the processes described above with reference to the flowcharts may be implemented as computer software programs. For example, the embodiments of the present application include a computer program product including a computer program carried on a computer-readable medium, the computer program containing program code for performing the method shown in the flowcharts. In such embodiments, the computer program may be downloaded and installed from a network through the communication device, installed from the storage device, or installed from the ROM. When executed by the processing device, the computer program performs the functions defined in the methods of the embodiments of the present application.

The electronic device provided by the present application employs the intelligent driving risk warning method in the foregoing embodiments, thereby solving the technical problem in the related art that safety risks are relatively high during intelligent driving due to system limitations. Compared with the related art, the beneficial effects of the electronic device provided by the embodiments of the present application are the same as the beneficial effects of the intelligent driving risk warning method provided by the foregoing embodiments, and other technical features of the electronic device are the same as those disclosed for the method in the foregoing embodiments and will not be repeated herein.

It should be understood that the various portions of the present application may be implemented in hardware, software, firmware, or a combination thereof. In the foregoing description of the embodiments, specific features, structures, materials, or characteristics may be combined in any suitable manner in one or more embodiments or examples.

The foregoing is only illustrative of specific embodiments of the present application, and the protection scope of the present application is not limited thereto. Any changes or substitutions that can be readily conceived by those skilled in the art within the technical scope disclosed by the present application shall fall within the protection scope of the present application. Therefore, the protection scope of the present application shall be subject to the protection scope of the claims.

This embodiment provides a computer-readable storage medium having computer-readable program instructions stored thereon, the computer-readable program instructions being used for performing the intelligent driving risk warning method in the foregoing embodiments.

The computer-readable storage medium provided in the embodiments of the present application may, for example, be a USB flash drive, but is not limited to, an electrical, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In this embodiment, the computer-readable storage medium may be any tangible medium that can contain or store a program for use by or in connection with an instruction execution system, apparatus, or device. Program code contained on the computer-readable storage medium may be transmitted using any appropriate medium, including but not limited to wire, optical cable, radio frequency (RF), and the like, or any suitable combination of the foregoing.

The computer-readable storage medium may be included in the electronic device, or may exist independently without being assembled into the electronic device.

The computer-readable storage medium carries one or more programs, and when the one or more programs are executed by an electronic device, the electronic device is caused to: acquire vehicle driving information in response to determining that the first vehicle is in an intelligent driving state; perform risk data detection in response to determining that the vehicle driving information satisfies a preset potential risk condition; and output intelligent driving risk warning information in response to determining, by performing risk assessment based on the risk data through a preset risk assessment model, that the first vehicle has an intelligent driving risk.

Computer program code for carrying out operations of the present application may be written in one or more programming languages, or any combination thereof. The programming languages include object-oriented programming languages, such as Java, Smalltalk, and C++, as well as conventional procedural programming languages, such as the “C” language or similar programming languages. The program code may execute entirely on a user computer, partly on a user computer, as a standalone software package, partly on a user computer and partly on a remote computer, or entirely on a remote computer or server. In a scenario involving a remote computer, the remote computer may be connected to the user computer through any type of network, including a local area network (LAN) or a wide area network (WAN), or may be connected to an external computer (for example, through the Internet via an Internet service provider).

The flowcharts and block diagrams in the drawings illustrate possible architectures, functions, and operations of systems, methods, and computer program products according to various embodiments of the present application. In this regard, each block in the flowcharts or block diagrams may represent a module, a program segment, or a portion of code containing one or more executable instructions for implementing specified logical functions. It should also be noted that, in some alternative implementations, the functions indicated in the blocks may occur in an order different from that indicated in the drawings. For example, two blocks shown in succession may, in fact, be executed substantially in parallel, and may sometimes be executed in the reverse order, depending on the functions involved. It should also be noted that each block of the block diagrams and/or flowcharts, and combinations of blocks in the block diagrams and/or flowcharts, can be implemented by special-purpose hardware-based systems that perform the specified functions or operations, or by combinations of special-purpose hardware and computer instructions.

The modules described in the embodiments of the present application may be implemented in software, or may be implemented in hardware. In some circumstances, the names of the modules do not constitute a limitation on the modules themselves.

The computer-readable storage medium provided by the present application stores computer-readable program instructions for performing the above intelligent driving risk warning method, thereby solving the technical problem in the related art that safety risks are relatively high during intelligent driving due to system limitations. Compared with the related art, the beneficial effects of the computer-readable storage medium provided by the embodiments of the present application are the same as the beneficial effects of the intelligent driving risk warning method provided by the foregoing embodiments and will not be repeated herein.

The present application further provides a computer program product including a computer program, wherein, when the computer program is executed by a processor, the steps of the above intelligent driving risk warning method are implemented.

The computer program product provided by the present application solves the technical problem in the related art that safety risks are relatively high during intelligent driving due to system limitations. Compared with the related art, the beneficial effects of the computer program product provided by the embodiments of the present application are the same as the beneficial effects of the intelligent driving risk warning method provided by the foregoing embodiments and will not be repeated herein.

The foregoing descriptions are merely embodiments of the present application and are not intended to limit the patent scope of the present application. Any equivalent structural or process transformations made by using the contents of the description and drawings of the present application, or any direct or indirect application thereof in other related technical fields, shall likewise fall within the patent protection scope of the present application.

What is claimed is:

1. An intelligent driving risk warning method, applied to a first vehicle, comprising:
in response to determining that the first vehicle is in an intelligent driving state, acquiring vehicle driving information;
in response to determining that the vehicle driving information satisfies a preset potential risk condition, performing risk data detection; and
in response to determining, by performing risk assessment based on risk data through a preset risk assessment model, that the first vehicle has an intelligent driving risk, outputting intelligent driving risk warning information.

2. The intelligent driving risk warning method according to claim 1, wherein the in response to determining that the first vehicle is in the intelligent driving state, acquiring the vehicle driving information comprises:
after the first vehicle is powered on and starts operating, continuously monitoring whether the first vehicle enters the intelligent driving state, and after detecting that the first vehicle enters the intelligent driving state, acquiring current vehicle driving information of the first vehicle.

3. The intelligent driving risk warning method according to claim 1, wherein the in response to determining that the vehicle driving information satisfies the preset potential risk condition, performing the risk data detection comprises:
determining whether the vehicle driving information satisfies the preset potential risk condition; and in response to that the vehicle driving information satisfies the preset potential risk condition, determining that the first vehicle has a potential risk, and then further performing detection on one or more risk items to obtain risk data respectively corresponding to the risk items.

4. The intelligent driving risk warning method according to claim 1, wherein the in response to determining, by performing risk assessment based on the risk data through the preset risk assessment model, that the first vehicle has the intelligent driving risk, outputting the intelligent driving risk warning information comprises:
inputting the risk data into the preset risk assessment model;
determining, by the preset risk assessment model based on the risk data, whether the first vehicle has the intelligent driving risk; and
in response to determining, by performing risk assessment based on the risk data through the preset risk assessment model, that the first vehicle has the intelligent driving risk, outputting the intelligent driving risk warning information.

5. The intelligent driving risk warning method according to claim 1, wherein the risk data comprises at least one of a perception confidence and a fusion confidence, and the performing the risk data detection comprises:
acquiring first target object information of a target object at a plurality of consecutive time steps, and determining the perception confidence according to differences among the first target object information; and/or
acquiring a plurality of pieces of second target object information corresponding to the target object, and determining the fusion confidence according to differences among the second target object information, wherein the second target object information is obtained by different perception modules sensing the target object at the same time.

6. The intelligent driving risk warning method according to claim 5, wherein the risk assessment model comprises an acceleration risk assessment model, and the risk data further comprises at least one of host vehicle acceleration and first external environment information, and the performing the risk assessment based on the risk data through the preset risk assessment model comprises:
determining, by the acceleration risk assessment model, whether more than a first preset number of the risk data satisfy a preset acceleration risk warning condition, wherein the preset acceleration risk warning condition comprises at least one of:
the perception confidence exceeding a first preset perception confidence threshold,
the fusion confidence exceeding a first preset fusion confidence threshold,
the host vehicle acceleration exceeding a first preset acceleration threshold, and
identifying, based on the first external environment information, that at least one intersection exists within a first preset distance range ahead of the first vehicle.

7. The intelligent driving risk warning method according to claim 5, wherein the risk assessment model comprises a deceleration risk assessment model, and the risk data further comprises host vehicle deceleration, and the performing the risk assessment based on the risk data through the preset risk assessment model comprises:
determining, by the deceleration risk assessment model, whether more than a second preset number of the risk data satisfy a preset deceleration risk warning condition, wherein the preset deceleration risk warning condition comprises at least one of: the perception confidence exceeding a second preset perception confidence threshold, the fusion confidence exceeding a second preset fusion confidence threshold, and the host vehicle deceleration exceeding a first preset deceleration threshold.

8. The intelligent driving risk warning method according to claim 5, wherein the risk assessment model comprises a steering risk assessment model, and the risk data further comprises at least one of road information, environmental perception data, and an actual steering direction, and the performing the risk assessment based on the risk data through the preset risk assessment model comprises:
acquiring an intelligent-driving-designated steering direction; and
determining, by the steering risk assessment model, whether more than a third preset number of the risk data satisfy a preset steering risk warning condition, wherein the preset steering risk warning condition comprises at least one of:
the perception confidence exceeding a third preset perception confidence threshold,
the fusion confidence exceeding a third preset fusion confidence threshold,
identifying, based on the environmental perception data, that at least one target object exists within a second preset distance range on the left and right sides of the first vehicle,
identifying, based on the road information, that at least one steering-risk road segment exists within a third preset distance range from the first vehicle, and
the actual steering direction being different from the intelligent-driving-designated steering direction,
wherein the steering-risk road segment comprises at least one of an intersection, a complex lane line road segment, and a sharp-turn road segment.

9. The intelligent driving risk warning method according to claim 1, wherein the risk assessment model comprises an overtaking lane-change risk assessment model, the risk data further comprises at least one of an overtaking lane-change command and a steering speed, and the performing the risk assessment based on the risk data through the preset risk assessment model comprises:
determining, by a preset overtaking lane-change risk assessment model, whether more than a fourth preset number of the risk data satisfy a preset overtaking lane-change risk warning condition, wherein the preset overtaking lane-change risk warning condition comprises at least one of detecting the overtaking lane-change command and the steering speed exceeding a first preset steering speed threshold.

10. The intelligent driving risk warning method according to claim 1, wherein the vehicle driving information comprises at least one of host vehicle acceleration, host vehicle deceleration, and steering speed, and the in response to determining that the vehicle driving information satisfies the preset potential risk condition, performing the risk data detection comprises:
in response to detecting that target vehicle driving information satisfying the preset potential risk condition exists in the vehicle driving information, detecting risk data corresponding to the target vehicle driving information, wherein the preset potential risk condition comprises at least one of the host vehicle acceleration exceeding a second preset acceleration threshold, the host vehicle deceleration exceeding a second preset deceleration threshold, and the steering speed exceeding a second preset steering speed threshold.

11. The intelligent driving risk warning method according to claim 5, wherein the first target object information comprises at least one of obstacle detection information, a first obstacle category, a first obstacle speed, a first obstacle size, target lane line detection information, and a first target lane line category, and the determining the perception confidence according to the differences among the first target object information comprises:
in response to determining according to the obstacle detection information that a perception module fails to recognize an obstacle at at least one time step, determining that the perception confidence corresponding to the obstacle detection information is a first preset value, wherein the first preset value is greater than a preset perception suspiciousness threshold; and/or
in response to that at least two different obstacle categories are detected among the first obstacle categories, determining that the perception confidence corresponding to the first obstacle category is a second preset value, wherein the second preset value is greater than the preset perception suspiciousness threshold; and/or
in response to that a difference between first obstacle speeds at any two adjacent time steps exceeds a first preset speed threshold, determining that the perception confidence corresponding to the first obstacle speed is a third preset value, wherein the third preset value is greater than the preset perception suspiciousness threshold; and/or
in response to that a difference among the first obstacle sizes exceeds a first preset size threshold, determining that the perception confidence corresponding to the first obstacle size is a fourth preset value, wherein the fourth preset value is greater than the preset perception suspiciousness threshold; and/or
in response to determining according to the target lane line detection information that the perception module fails to recognize a target lane line at at least one time step, determining that the perception confidence corresponding to the target lane line detection information is a fifth preset value, wherein the fifth preset value is greater than the preset perception suspiciousness threshold;
and/or
in response to that at least two different lane line categories are detected among the first target lane line categories, determining that the perception confidence corresponding to the first target lane line category is a sixth preset value, wherein the sixth preset value is greater than the preset perception suspiciousness threshold.

12. The intelligent driving risk warning method according to claim 5, wherein the second target object information comprises at least one of a second obstacle category, an obstacle position, a second obstacle speed, and a second obstacle size, and the determining the fusion confidence according to the differences among the second target object information comprises:
in response to that at least two different obstacle categories are detected among the second obstacle categories, determining that the fusion confidence corresponding to the second obstacle category is a fifth preset value, wherein the fifth preset value is greater than a preset fusion suspiciousness threshold;
in response to that the second obstacle categories are all the same, determining whether the second obstacle category is an unknown category, and detecting whether a distance among the obstacle positions exceeds a preset distance threshold;
in response to that the distance among the obstacle positions exceeds the preset distance threshold, or in response to that the distance among the obstacle positions does not exceed the preset distance threshold and the second obstacle category is the unknown category, determining that the fusion confidence corresponding to the obstacle position is a sixth preset value, wherein the sixth preset value is greater than the preset fusion suspiciousness threshold;
in response to that the distance among the obstacle positions does not exceed the preset distance threshold and the second obstacle category is not the unknown category, detecting whether a difference among the second obstacle speeds exceeds a second preset speed threshold;
in response to that the difference among the second obstacle speeds exceeds the second preset speed threshold, determining that the fusion confidence corresponding to the second obstacle speed is a seventh preset value, wherein the seventh preset value is greater than the preset fusion suspiciousness threshold;
in response to that the difference among the second obstacle speeds does not exceed the second preset speed threshold, detecting whether a difference among the second obstacle sizes exceeds a second preset size threshold; and
in response to that the difference among the second obstacle sizes exceeds the second preset size threshold, determining that the fusion confidence corresponding to the second obstacle size is a eighth preset value, wherein the eighth preset value is greater than the preset fusion suspiciousness threshold.

13. An intelligent driving risk warning apparatus, wherein the intelligent driving risk warning apparatus is applied to a first vehicle, comprising:
an acquisition module configured to, in response to determining that the first vehicle is in an intelligent driving state, acquire vehicle driving information;
a detection module configured to, in response to determining that the vehicle driving information satisfies a preset potential risk condition, perform risk data detection; and
an output module configured to, in response to determining, by performing risk assessment based on risk data through a preset risk assessment model, that the first vehicle has an intelligent driving risk, output intelligent driving risk warning information.

14. An electronic device, comprising:
at least one processor; and
a memory communicatively connected to the at least one processor,
wherein the memory stores instructions executable by the at least one processor, and the instructions, when executed by the at least one processor, cause the at least one processor to perform the intelligent driving risk warning method according to claim 1.

15. A non-transitory computer-readable storage medium, wherein the medium stores a program for implementing an intelligent driving risk warning method, and the program, when executed by a processor, causes the processor to perform the intelligent driving risk warning method according to claim 1.

16. A product, wherein the product is a computer program product comprising a computer program, and the computer program, when executed by a processor, causes the processor to perform the intelligent driving risk warning method according to claim 1.
